(19) United States
(12) Patent Application Publication
(10) Pub. No.: US 2003/0112965 A1
(43) Pub. Date: Jun. 19, 2003

(54) Active wall outlet

(75) Inventors: Thomas F. McNamara, Auburn, MA (US); Soto D. Mareskes, Newton, MA (US)

Correspondence Address: John N. Anastasi, Wolf, Greenfield & Sacks, P.C., 600 Atlantic Avenue, Boston, MA, 02210, US

(73) Assignee: MEDIAMAX, INC., Woburn, MA

(21) Appl. No.: 10/323,454

(22) Filed: Dec. 18, 2002

Related U.S. Application Data
(60) Provisional application No. 60/341,566, filed on Dec. 18, 2001.

(51) Int. Cl. H04M 9/00; H04M 1/00

(52) U.S. Cl. 379/399.01

(57) ABSTRACT

An active wall outlet providing media and network switching at a desktop location. The active wall outlet facilitates implementing a structured cabling system having a backbone portion and a horizontal portion that employ optical cable as the primary transport media for a building, campus, and/or enterprise LAN. The active outlet may can be powered from a remote location providing network information and/or circuit switched data to devices located at the desktop.

### RELATED APPLICATIONS

This application claims priority under 35 U.S.C. § 119(e) to U.S. Provisional Application Serial No. 60/341,566, entitled “ACTIVE WALL OUTLET,” filed on Dec. 18, 2001, which is herein incorporated by reference in its entirety.

### FIELD OF THE INVENTION

The present invention relates to structured cabling in Local Area Networks serving a building and/or campus and, more particularly, to an active wall outlet for converting optical signals to electrical signals and switching network information at the active outlet between a plurality of devices connected to ports of the active outlet.

### BACKGROUND OF THE INVENTION

The ever increasing amount of information that Local Area Networks (LANs) are required to support threatens to surpass the bandwidth capabilities of traditional electrical media that forms the bulk of the transport structure of many existing building, campus and/or enterprise LANs. Moreover, it is often the various limitations imposed by electrical media, for instance, transmission link distances, that have given rise to the particular architecture of many of the structured cabling systems existing in today's LANs. The term “structured cabling system” refers generally to the arrangement, topology and/or constitution of the network components and cabling infrastructure comprising, for instance, an enterprise LAN.

A typical structured cabling system may include a computer equipment room (CER), also referred to as a central equipment room, connected to multiple telecommunications rooms (TRs) or telecommunications closets (TCs) distributed throughout the building and/or campus. Typically, the CER will house a network switch, for example, a Layer 2/3 LAN switch, which in conjunction with the cabling infrastructure connecting the CER to the various TRs forms, at least in part, a backbone portion of the structured cabling system. Similarly, each TR will often contain an additional switch, which in conjunction with the various equipment in the TR and the cabling infrastructure connecting the TRs to the desktop forms, at least in part, a horizontal portion of the structured cabling system.

A conventional structured cabling system is illustrated in FIG. 1. Structured cabling system 900 includes a central equipment room 400 which typically houses a LAN switch, for example, a Layer 2/3 LAN switch 401. Typically, the CER includes the various electronics equipment and cabling required to generate, switch, and/or propagate network information across the backbone cabling structure to the one or more TRs. The CER is variously referred to as the main distribution center (MDC).

CER 400 is connected to a plurality of telecommunications rooms 600A-600D distributed, for example, on separate floors of a building. Typically, a TR (e.g., any of TRs 600A-600D) includes the various electronic and/or optical components and cabling employed in generating, switching, distributing, and/or propagating network information across the horizontal cabling structure to one or more desktop locations.

The various TRs may be connected to a plurality of desktop locations located on, for instance, respective floors of the TRs. For example, TR 600A may be connected to desktop locations 700a-700c, TR 600B may be connected to desktop locations 700d and 700e, etc.

Accordingly, backbone 450 of structured cabling system 900 is formed by the CER 400 and the connections 465a-465d between the equipment room and the various TRs, for example, via electrical cables. A horizontal portion 650 of structured cabling system is formed by the various TRs 600A-600D and the connections 655a-655j linking the TRs and respective desktop locations. For example, connections 655a-655j forming the horizontal cabling may be electrical cables such as CAT 5 UTP cables.

The term desktop or desktop location refers generally to a single computing location including one or more computing, network, and/or peripheral devices. For example, a desktop may be an office or room containing one or more desktop devices including, but not limited to, workstations, personal computers, printers, facsimile (fax) machines, telephones, etc. Typically, any network service requirements of a desktop location will be provided through a wall outlet having one or more connections and/or network ports.

In FIG. 1, desktop locations 700a-700j each may include any of several desktop devices connected to the network. For example, desktop location 700a may have several ports providing network access for a workstation 710a, a network printer 720a, and a laptop personal computer 730a. Devices 710a-730a may be, for instance, connected to a passive wall outlet located at desktop location 700a. The term passive outlet is used to describe outlets that merely terminate and provide a connection for network cabling.

Network activity is switched by LAN switch 401 and network information is routed to the appropriate TRs depending on the ultimate destination of the network information. For example, LAN switch 401 may route any network information bound for any of the network devices connected at desktop locations 700a-700d to TR 600A. TR 600A may then identify which desktop device the network information is destined for and route the information to that particular device, for instance, to workstation 710a connected at desktop location 700a.

In structured cabling system 900, the connections 655a-655j comprise electrical cables such as CAT 5 UTP cable. It should be appreciated that since network information is switched at the TR, an individual cable must be pulled from the TR to each port at a desktop location to which a desktop device is connected. For example, in FIG. 1, at least nₐ electrical cables must be run from TR 600A to desktop location 700a where nₐ is the number of desktop devices transmitting and/or receiving network information at desktop location 700a. However, such a configuration provides a cumbersome horizontal cabling structure that is not only bulky but provides many points of failure, making the structured cabling system difficult to troubleshoot and expensive to maintain.

As noted above, many existing structured cabling systems have been designed in consideration of the various constraints imposed on the network by electrical cabling and infrastructure. For example, to accommodate limitations in transmission link distances, each floor of a building may require one or more TRs including network components such as switches, hubs, concentrators, etc. to provide an intermediate stage between the CER and the desktop with which to route the network activity to the various desktop locations connected to the TR. However, the large amounts of electronic components located in the TR make the rooms expensive to construct, requires significant space and power, requires the rooms to be properly ventilated, and introduces numerous points of failure in the network making the TR difficult to manage and maintain.

Optical media, such as optical fiber, has emerged as a technology capable of handling the expanding bandwidth and port density requirements of the modern enterprise LAN. Furthermore, optical technology offers numerous other advantages over electrical technology such as increased signal integrity, extended transmission distances, security, etc. However, the structured cabling systems have been slow to adopt optical technology for a number of reasons including the expense of migrating to optical fiber, the difficulty of reengineering a structured cabling system, and advances in the bandwidth of electrical media that have, presently, prevented it from becoming inadequate. For example, category 5 (CAT 5) unshielded twisted pair (UTP) cable has developed “enhanced” forms (e.g., CAT 5e and CAT 6) capable of supporting gigabit Ethernet, thus extending its usefulness and delaying the obsolescence of electrical cabling.

As such, the difficulties and expense required to transplant an electrical or copper infrastructure with designs that facilitate and exploit the benefits and advantages of optical technology have impeded an industry migration to optical cabling structures, particularly at the horizontal portion of the LAN.

The term “copper” is often used to describe any of the various media used in a cabling system to propagate electrical signals. For example, cable constructed from steel wires, for instance, would be considered a “copper” cable. In particular, the term “copper” is used to distinguish electrical technology from optical technology, including, but not limited to cabling, interfaces, connectors, components, etc. Although the term “electrical” will be preferably used herein to describe the body of technology and infrastructure related to transporting electrical signals, it should be appreciated that the term copper is often used in the field of networks and structured cabling systems to refer to an implementation of electrical technology.

### SUMMARY OF INVENTION

One embodiment according to the present invention includes an active wall outlet comprising at least one optical connector, a plurality of ports, a transceiver configured to convert between optical signals and electrical signals, the transceiver capable of transmitting and receiving optical signals to and from at least one optical connector, and a switch coupled to the transceiver and at least some of the plurality of ports, the switch configured to switch electrical signals between the transceiver and at least some of the plurality of ports.

Another embodiment according to the present invention includes a method of providing network information to a desktop comprising acts of providing at least one optical signal to an active outlet having a plurality of ports from a network over at least one first optical cable, converting the at least one optical signal to at least one electrical signal at the active outlet, and switching the at least one electrical signal amongst the plurality of ports at the active outlet.

Another embodiment according to the present invention includes a structured cabling system providing optical media to a plurality of desktops. The structured cabling system comprises at least one network switch located remote from the plurality of desktops, the at least one network switch configured to provide optical network information over at least one first optical cable, and at least one active wall outlet remote from the network switch having a plurality of ports, the active outlet capable of receiving the optical network information and configured to convert the optical network information to electrical network information and switch the electrical network information between the plurality of ports.

Another embodiment according to the present invention includes a structured cabling system for a Local Area Network (LAN) comprising a backbone portion providing optical network information over at least one optical cable, a horizontal portion connected to the backbone portion by at least one first optical cable, the horizontal portion capable of receiving the optical network information from the at least one first optical cable and providing the optical network information over a plurality of second optical cables, and a plurality of desktop locations connected to the horizontal portion by at least one of the plurality of second optical cables, each desktop location including an active wall outlet capable of receiving the optical network information over the at least one second optical capable, converting the optical network information into electrical network information and switching the electrical network information amongst a plurality of active wall outlet ports.

### BRIEF DESCRIPTION OF DRAWINGS

FIG. 1 illustrates a prior art structured cabling system;

FIG. 2 illustrates one embodiment of an active wall outlet according to the present invention that provides media conversion and network switching at a desktop;

FIG. 3 illustrates another embodiment of an active wall outlet according to the present invention including receiving power from a local and/or remote location;

FIG. 4 illustrates another embodiment of an active wall outlet according to the present invention including providing circuit switched data and optional network voice information;

FIG. 5 illustrates another embodiment of an active wall outlet according to the present invention including an optical fiber pass through;

FIG. 6 illustrates an embodiment of a patch panel providing power and/or circuit switched data to one or more remote active wall outlets according to the present invention;

FIG. 7 illustrates an embodiment of a structured cabling system according to the present invention including active outlets at desktop locations and a horizontal portion employing optical fiber as the primary transport media.

FIG. 8 illustrates another embodiment of the a structured cabling system according to the present invention including an optical collapsed backbone and active outlets at desktop locations.

FIG. 9 illustrates an embodiment incorporating various aspects of the present invention including an active outlet and a structured cabling system employing optical fiber as the primary transport media.

### DETAILED DESCRIPTION

Optical technology offers many advantages over electrical technology. For example, optical media does not suffer from radio frequency (RF) interference that often degrades electrical signals, is less vulnerable to being tapped, permits extended transmission distances, provides superior bandwidth, etc. Advances in optical technology has made optical fiber economical and easier to handle and has made optical components easier to test and maintain. Optical cable has been employed in various local area networks, replacing electrical cabling as the primary media in constructing the backbone of the LAN. However, the horizontal portion of the LAN remains largely electrical and is often the main bottleneck in the network and is frequently the segment of the network most often updated and reengineered.

The term “cable” refers generally to any assembly of one or more conductors capable of transmitting signals over its length. In particular, an electrical cable is capable of transmitting electrical signals over its length and an optical cable is capable of transmitting optical signals over its length. For example, an unshielded twisted pair (UTP) configuration is a widely used technology in electrical cabling (e.g., category 3 (CAT 3) cables, category 5 (CAT 5) cable, etc.). Optical cable, often referred to as fiber-optic cable, or simply fiber includes single mode (SM), multimode (MM) fiber optic cable, etc.

Many of the factors that have frustrated migration to optical media for the horizontal portion of the structured cabling system have been mitigated for the backbone. For example, the backbone of a structured cabling system typically enjoys more permanence than the horizontal portion. For instance, the bulk of the equipment and electronics components both in the TR and at desktop locations that may be subject to change due to advances in technology, increased bandwidth requirements, modifications to the number and type of devices at the desktop, changes in location of the desktop, etc., may have limited or no effect on the architecture of the backbone.

Furthermore, many existing electrical structured cabling systems were designed around the multiple TR model and, as such, have rendered placing additional electrical and/or optical equipment, such as media converters, into existing TRs a relatively simple and inexpensive solution to creating an optical backbone without disturbing the horizontal portion of the system. As such, the backbone of the structured cabling system may be transitioned to optical media without the expense of overhauling the entire structured cabling system and replacing much of the existing network components. However, the horizontal portion of the structured cabling system is not so amenable to transition and presents many obstacles to optical media migration. As such, the horizontal portion of the structured cabling system has remained largely electrical.

As noted above, network service at a desktop location will conventionally be accessed through a passive wall outlet having one or more ports or network connections. The link between the wall outlet and the various desktop devices is predominantly electrical and for many reasons may remain so for quite some time. For instance, network interface cards (NICs) and many standard device interfaces and connectors provided on desktop devices are based on electrical technology. Furthermore, the relatively short link distances between an outlet and a desktop device presents little risk of bandwidth saturation for electrical media. As such, a structured cabling system exploiting optical technology along some portion will, at some point, convert the optical signals to electrical signals.

In structured cabling systems having optical fiber backbones, media conversion has typically taken place in the TR such that optical signals are converted and switched in the TR and then transported to the desktop with electrical cabling. This design has the various drawbacks noted in the foregoing, most notably, large numbers of electrical cabling, switching and media conversion capabilities in the TR, etc. For some centralized cabling structures, for example, the TIA/EIA 568-B.3 design, much of the switching and media conversion formerly done in the TR may be moved back and provided for in the CER. However, this solution requires that separate optical cables be run from the CER to every port in the wall outlet. This increases the size of the backbone network and underutilizes the bandwidth of optical media.

Applicant has identified and appreciated the desirability of at least partially replacing the horizontal segment of the LAN with optical fiber, that is, providing optical media to transport information, data and communications all the way to the desktop. Accordingly, one embodiment of the present invention includes providing an active wall outlet capable of converting optical media to electrical media and switching network information among a plurality of ports included at the active wall outlet. As such, the benefits of increased bandwidth, superior link distances, security, signal integrity, etc. offered by optical media may be utilized by providing an active wall outlet that handles network switching and media conversion requirements at the desktop.

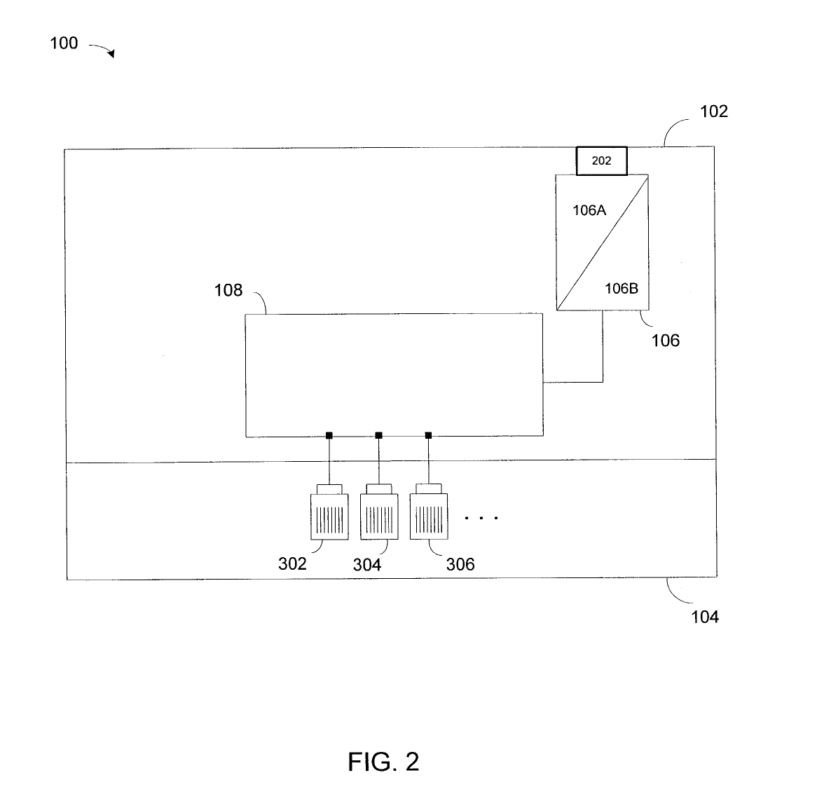

FIG. 2 illustrates an embodiment of an active wall outlet according to the present invention. The term active wall outlet refers generally to a self-contained unit having one or more active components. Active wall outlet 100 has a backside 102 and a front face 104. In general, the backside refers to the portion of the active wall outlet interfacing with the network and the front face refers to the portion of the active wall outlet interfacing with the desktop devices. For example, the connections involved in receiving signals from and transmitting signals to, for instance, a TR and/or CER will typically be located on the backside of the wall outlet. Similarly, the connections involved in receiving signals from and transmitting signals to the various desktop devices are typically located on the front face of the active wall outlet.

As illustrated in FIG. 2, the back side 102 of the active wall outlet 100 may include a fiber optic connector 202. Fiber optic connector 202 may be any type of connector suitable for terminating fiber optic media, for example, a Small Form Factor (SFF) connector for terminating an optical cable. The front face 104 of active wall outlet 100 may include a plurality of electrical connectors 302, 304 and 306, etc. The electrical connectors may be of any type suitable for terminating electrical media, for example, RJ45 connectors for terminating standard CAT 5 or any other variety of electrical cable. Electrical connectors 302, 304 and 306 may, for instance, provide a plurality of network ports providing network access for devices located at the desktop.

The active outlet 100 further includes a transceiver 106 for converting between optical signals and electrical signals and switch 108 capable of receiving electrical signals from the transceiver and switching them amongst the plurality of ports and providing the transceiver with electrical signals received from, for instance, devices connected at the plurality of ports. Transceiver 106 may be coupled to optical connector 202 at an optical side 106a of the transceiver to transmit and receive optical signals to and from the network. Similarly, transceiver 106 may be coupled to switch 108 at an electrical side 106b to receive and transmit electrical signals to and from the desktop devices. Transceiver 106 may be any media conversion component capable of converting optical signals to electrical signals and vice versa. Switch 108 may be of any type capable of switching signals amongst a plurality of ports. For example, switch 108 may be an Ethernet switch.

Accordingly, the active wall outlet may receive network information as optical signals (i.e., optical network information) from, for example, a Local Area Network (LAN) over a fiber-optic cable connected to fiber-optic connector 202. The transceiver may receive the optical signals from connector 202, convert the optical signals received at connector 202 to electrical signals and provide the electrical signals to switch 108. Switch 108 may receive the electrical signals from the transceiver and switch the electrical signals to the appropriate connectors 302, 304, 306, etc. on the front face of the active wall outlet.

Similarly, active wall outlet 100 may receive network information as electrical signals (i.e., electrical network information) from, for example, desktop devices connected to the plurality of ports on the front face of the active wall outlet. For example, switch 108 may receive electrical signals from the front face connectors and provide the signals to transceiver 106. The transceiver converts the electrical signals into optical signals and transmits the optical signals to fiber-optic connector 202. The optical network information converted from the electrical network information may be transmitted, for example, to the LAN over fiber-optic cable 402. In this manner, network information may be transmitted between various desktop devices using optical fiber as the primary transport media all the way to the desktop.

Accordingly, active wall outlet 100 provides media conversion and switching between and amongst the network and network devices. For example, a desktop location including a personal computer (PC), a printer, and a lap-top may be connected to connectors 302, 304 and 306, respectively, to provide network access for each of the desktop devices. As such, the multiple electrical cables required in conventional structured cabling systems connecting, for example, the TR with the passive wall outlet, may be replaced with a single fiber optic cable (e.g., fiber optic cable 402).

It should be appreciated that the active outlet may include any number of electrical connectors and is not limited to the number illustrated in FIG. 2, and may depend on the requirements and characteristics of a particular desktop location. Active outlet 100 may be designed to fit in a standard 4 inch by 4 inch wall fixture, a 4 inch by 6 inch wall outlet fixture, or any other size fixture as desired.

Interruption in power, for instance, caused by blackouts, damage to the power lines from the utility power grid, failures internal to a building, etc., may cause information at a desktop location to be lost. Applicant has appreciated that many of the problems associated with using local and/or standard wall power may be mitigated or eliminated by providing an active wall outlet capable of being powered from a secure central power source.

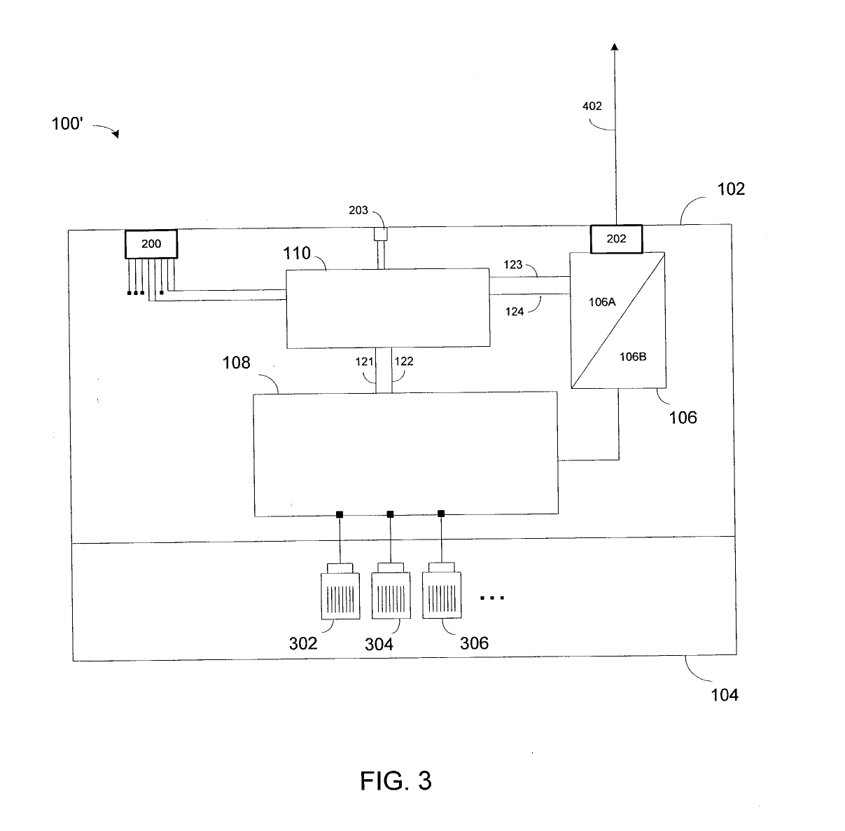

FIG. 3 illustrates one embodiment of an active wall outlet according to the present invention. Active wall outlet 100′ may be configured to be powered from either a local or remote location. Active outlet 100′ may be similar to the active wall outlet illustrated in FIG. 2. In addition, though, the backside 102 may further include an electrical connector 200. Electrical connector 200 may be of any type suitable for terminating electrical media, for example, an RJ45 connector for terminating standard CAT 5 or any other variety of electrical cable. Electrical connector 200 is illustrated as an 8-pin connector, however, the connector is not limited to any number or arrangement of pins.

The term “pin” refers generally to any connection point configured such that signals, when applied to the pin, may be transferred to any of various media operatively connected at the connection point. For example, pins refer to the various connection, transmission and/or termination points of cables, connectors, electrical and/or optical components, etc. The term “set”, for example, a set of pins, refers to any predetermined, preselected and/or prearranged group of one or more elements (e.g., pins).

Active wall outlet 100′ may further include a power converter 110. Power converter 110 may be any suitable component capable of receiving power from an external source and converting it to a level appropriate for supplying power to one or more of the various components of the active wall outlet. Power converter 110 may be coupled to a set of pins, for example, pins 4, 5, 7 and 8 of connector 200. As such, power may be supplied from a remote location and transported over, for instance, a CAT 5 cable to electrical connector 200. Power converter 110 may convert the power received over its connection to the pins of connector 200 and distribute it appropriately to the components of the active wall outlet. For example, power converter 110 may be connected to transceiver 106 via supply lines 123 and 124 and to switch 108 via supply lines 121 and 122 in order to provide power to operate the components.

It should be appreciated that many different arrangements of pin connections and types of connectors may be employed to effectively receive power from a remote source. For example, power received at connector 200 may be implemented according to the IEEE 802.3af standard for providing power over twisted pair media, such as a CAT 3 or CAT 5 UTP cable, which is hereby incorporated by reference in its entirety. Moreover, power provided according to this standard or any other standard or suitable method may be applied to any number or arrangement of pins on the power source, connector, cable, etc. It should be appreciated, that standards may develop in the future to encompass different technologies and definitions may change to recognize improved cable types and/or to meet evolving needs. However, any such method and/or apparatus for receiving, transporting and providing power from a remote location to power, for example, an active outlet over electrical cable is considered to be within the scope of the invention.

Active wall outlet 100′ may also include a connector 203 for receiving power from a local source, for example, standard brick or wall power. Connector 203 may be adapted to connect to, for example, a local power outlet to receive standard AC power from the wall. Power connector 203 thus permits power to be provided locally, for instance, for testing the outlet or when no remote power source is available. Accordingly, power converter 110 may be configured to convert either power received remotely, from a local source, or both and provide it to the various components of the active wall outlet.

Many desktop locations may continue to use telephone service provided through traditional circuit switched or analog telephone systems, sometimes referred to as plain old telephone service (POTS). However, as networks become more capable of meeting the requirements of transmitting voice data, perhaps in part due to the migration to higher bandwidth optical media, telephony servers may be connected to the desktop to provide telephone service over the LAN, for instance, in a Voice-over-Internet Protocol (VoIP) type framework.

Applicant has identified and appreciated the desirability of providing for either POTS or network telephone service via the active wall outlet. By providing both POTS and, for example, VoIP capability, an active wall outlet may be immediately employed at desktop locations installed with either type of telephone service and may be transitioned from POTS to network service or vice-versa without having to replace the outlet should a desktop location migrate to network provided voice service or should circumstances require alternate analog telephone service.

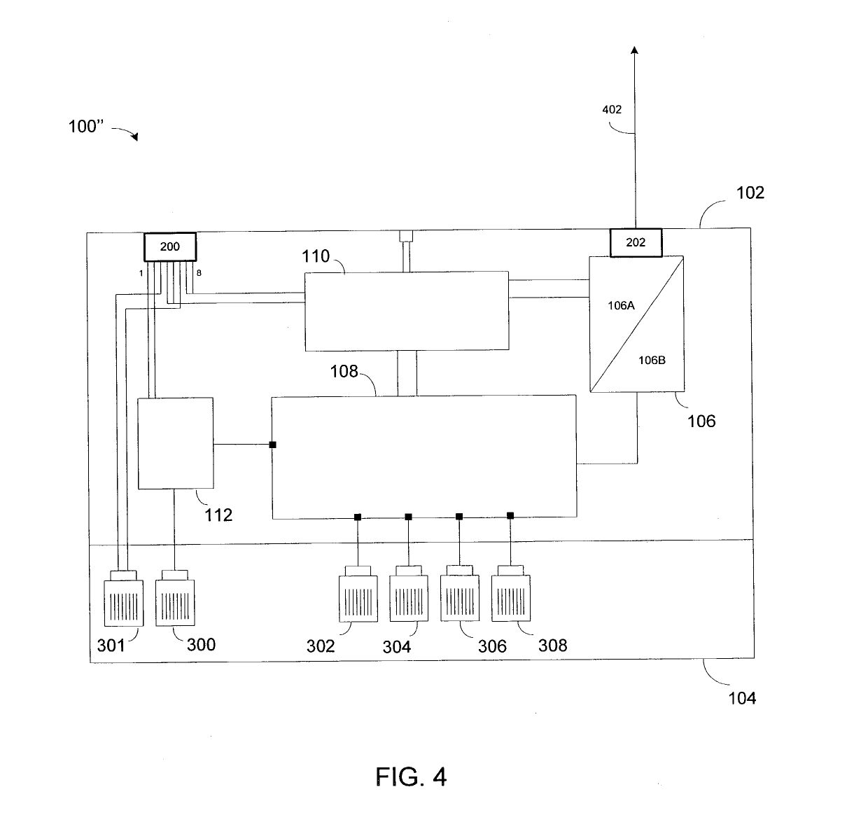

FIG. 4 illustrates another embodiment of an active wall outlet according to the present invention. Active outlet 100″ may be similar to active wall outlet 100′ shown in FIG. 3. However, active outlet 100″ may be configured to provide both POTS and/or network voice service. The active wall outlet may include an additional electrical connector 300 to allow, for instance, a telephone to be connected to the front face 104 of the active wall outlet. Electrical connector 300 may be any connector suitable for terminating electrical signals, and more particularly, for providing proper termination for voice signals. For example, connector 300 may be an RJ45, RJ11 or RJ21 type jack connector used to terminate standard telephone cables, etc.

In addition, active outlet 100″ may include a DIP switch 112 connected to a set of pins, for instance, pins 1 and 2 of electrical connector 200 and to electrical connector 300. DIP switch 112 may be configured to pass the signals at pins 1 and 2 to connector 300 on the front face such that POTS service may be provided to devices connected to the active outlet. DIP switch 112 may be further connected to switch 108. As such, DIP switch 112 may be configured such that instead of passing signals received at electrical connector 200, the DIP switch passes signals received from the switch 108. For example, if network telephone service is available, voice data may be received from the LAN at optical connector 202, converted into electrical voice data, switched by switch 108 and provided to electrical connector 300 via DIP switch 112. The DIP switch may be manually configured to either pass the voice signals received from connector 200 or voice signals received from the switch 108 and, as such, electrical connector 300 may be configured as a POTS jack or a network port for receiving and transmitting, for example, analog or network voice information depending on the particular desktop location. The type of service provided by the active outlet may be switched at any time by appropriately setting the DIP switch to pass the desired voice signals through to electrical connector 300. DIP switch 112 may be replaced by any suitable switching device capable of selectively providing signals received from one more sources to a destination as desired.

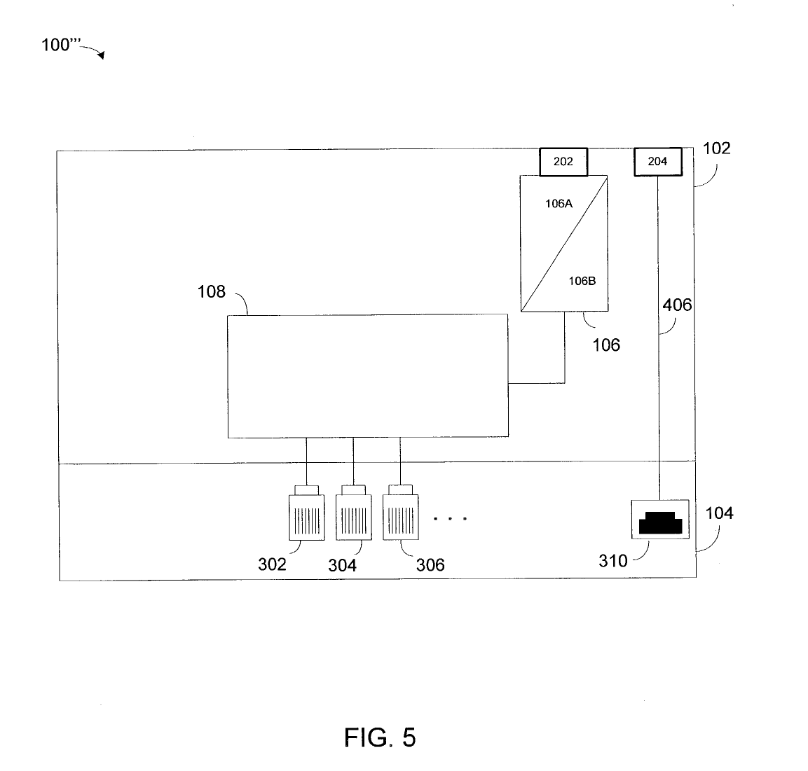

An additional electrical connector 301 may be provided on the front face of the active wall outlet such that, for example, either another analog telephone port or a fax/modem port may be provided at the desktop by active wall outlet 100″. According to one aspect of the embodiment illustrated in FIG. 5, connector 301 is connected to a set of pins, for instance, pins 3 and 6 of the electrical connector 200. As such, active wall outlet provides all of the network, voice and data services required by most desktop locations.

As such, active wall outlet 100″ is capable of receiving power from a remote location to power the device and also may receive voice and/or data signals to provide POTS and/or fax/modem services at a single electrical connector. That is, a single cable can be pulled from, for example, a TR to the active wall outlet to provide both power, voice, and data signals to the active wall outlet.

As discussed in the foregoing and, more particularly, in connection with the embodiment illustrated in FIGS. 3 and 4, an active outlet may be configured to receive power and/or data from a remote location, allowing for a centralized distribution of power and obviating the need to rely on, for instance, local power outlets, and facilitates the use of centralized UPSs.

FIG. 5 illustrates another embodiment of the present invention that facilitates the provision of, for example, Gigabit Ethernet or other services such as Asynchronous Transmission Mode (ATM) or other Wide-Area Network (WAN) services. Active wall outlet 100′″ may be similar to any of the active wall outlets described in connection with FIGS. 2, 3 and 4. However, active outlet 100′″ may include one or more additional optical connectors provided on the back side and/or front face of the active outlet in order to provide a fiber optic cable pass-through. For example, an SFF connector 204 provided on the back side of the active outlet may be internally connected to an SFF optical connector 310 on the front face 104. As such, active outlet 100′″ is configured to provide both LAN access at electrical connector 202 and WAN and/or ATM services via connector 204, over fiber optic pass through 406 and connector 310 at the desktop.

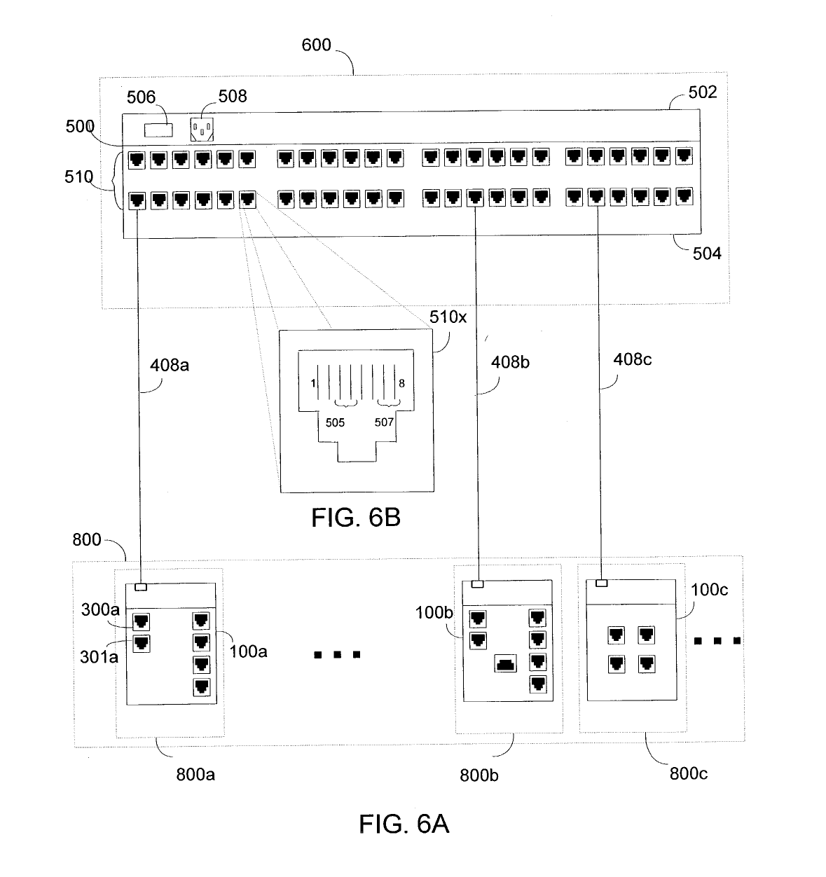

FIG. 6A illustrates one embodiment of a patch panel providing power and/or circuit switched data to a plurality of active outlets according to the present invention. The term circuit switched data refers generally to data received over conventional circuit switched networks (i.e., as opposed to packet switched networks). Circuit switched data includes, but is not limited to, voice, fax and modem information transmitted across a circuit switched network.

Patch panel 500 includes a plurality of ports 510 located, for instance, on a side 504 of the patch panel. Patch panel 500 may further include a connector 506 and a power connector 508 located on a side 502 of the patch panel. Power connector 508 permits power to be provided to the patch panel from, for instance, a secure centralized power source. For example, power connector 508 may be a standard power connector configured to receive a −48 VDC supply, standard AC power from the wall, power from an uninterruptible power source (UPS), etc. Connector 506 may be any connector suitable for terminating electrical cable and, more particularly, electrical cable providing circuit switched data such as voice, fax and/or modem information. For example, connector 506 may provide termination for a 25 pair cable configured to provide data from a switch (not shown) configured for circuit switched data, for example the circuit switch providing telecommunications data to the building, campus and/or complex.

Each of the plurality of ports 510 may include a plurality of pins. For example, ports 510 may be 8-pin connectors as illustrated in the magnified view 510x of one of individual ports 510 in FIG. 6B. Patch panel 500 may be configured to receive voice signals from connector 506 and a power signal from power connector 508 and provide the signals to predetermined pins on each of the ports 510. For example, patch panel 500 may provide voice signals 505 to pins 4 and 5 and power signals 507 to pins 7 and 8 of each of the ports 510 as illustrated in magnified view 510x of FIG. 6B. Moreover, patch panel 500 may be configured to provide additional data to other pins of ports 510. For example, patch panel 500 may receive data such as fax and/or modem information at connector 506 and provide the data to, for instance, pins 1 and 2 of respective ports 510.

It should be appreciated that patch panel 500 need not be configured to provide circuit switched information, for example, the patch panel may not include connector 506 such that patch panel 500 provides only power. Similarly, patch panel 500 need not be configured to provide power, for example, the patch panel may not include connector 508 such that patch panel 500 provides only circuit switched data. Furthermore, any number of ports may be configured to receive power and/or circuit switched data. For example, one, a subset, or all of the ports provided on the panel may be configured to provide power and/or circuit switched data to any number and arrangement of pins at the ports. Accordingly, the many variations with regard to the arrangement and configuration of a patch panel configured to provide power and/or circuit switched data that will readily occur to those skilled in the art, such as, the number of ports, the number of pins at each port, the choice of pins providing power and/or voice signals, etc., are considered to be within the scope of the present invention.

In one embodiment, patch panel 500 is configured to convert and apply power received from connector 508 as necessary to the various pins of a set of the ports 510 in compliance with the IEEE 802.3af standard. As such, patch panel 500 may be configured to provide power to a plurality of desktop locations over a twisted pair link segment such as a CAT 5 UTP cable. For example, patch panel 500 may provide power and/or circuit switched data to desktop locations 800a-800c over electrical cables 408a-408c, respectively. The patch panel may be configured to receive power from a midspan power source or may be configured to receive power from a UPS. For example, a UPS unit may be included in the TR to provide uninterrupted power to desktop devices in case of blackouts or other interruptions in power supplied from the utility company.

Patch panel 500 may be located remote from a desktop location, for example, in a TR 600. Each port may be configured to provide power and/or circuit switched data to an individual desktop location connected to the TR. As such, patch panel 500 may provide power and/or circuit switched data from a secure and centralized location to a plurality of desktop locations, for example, one or more desktops located on a floor 800 as illustrated in FIG. 6A.

Patch panel 500 is illustrated as providing power and/or circuit switched data to a number of active outlets 100a-100c. Each of active outlets 100a-100c may be provided at separate desktop locations 800a-800c and may be configured as desired to accommodate the individual voice, data, and/or network needs of a particular desktop location. For example, active outlet 100a at desktop location 800a may be provided with four network ports and two standard telephony ports providing, for instance, configurable POTS or VoIP service at port 300a and fax/modem service at port 301a. Active outlet 100b at desktop location 800b may be provided with an optical fiber pass through port to provide, for example, WAN or ATM services, etc.

Patch panel 500 may be configured to provide power and/or circuit switched data over an electrical cable, for example, a CAT 5 cable. As illustrated in FIG. 6A, CAT 5 cables 408a-408c provide power and/or circuit switched data from the patch panel located in the TR to respective active outlets of the various desktop locations connected to the patch panel. It should be appreciated that the patch panel may provide power and/or circuit switch data to any number or arrangement of desktop locations, for example, on the same or different floors of a building or office complex.

Installing, replacing, or modifying a network cabling system often requires consideration of a number of important factors, including, but not limited to, installation costs of the network, costs of maintaining the network, the cost of upgrading the network to support new technologies, etc. Applicants have recognized and appreciated that various aspects of the active wall outlet according to the present invention facilitate migration to structured cabling systems that employ optical fiber as the primary transport media of the network.

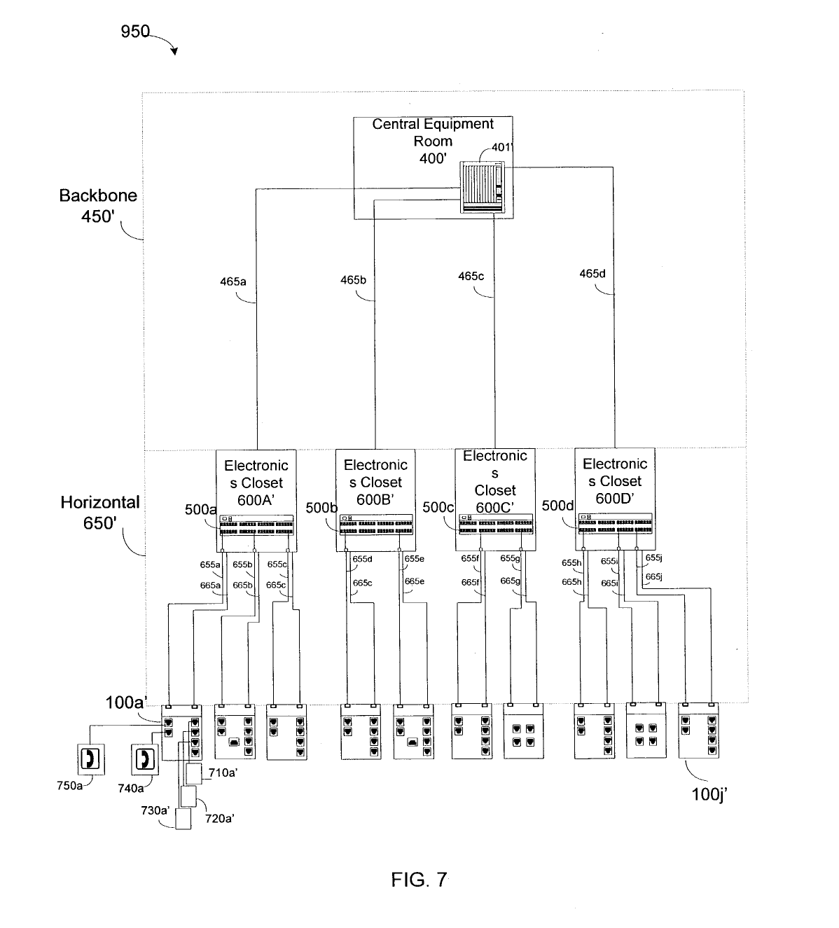

FIG. 7 illustrates one embodiment of a structured cabling system according to the present invention. Structured cabling system 950 includes a backbone 450′ and a horizontal portion 650′. Backbone 450′ includes CER 400′ and a LAN switch 401′. The backbone cabling infrastructure, for example, connections 465a-465d may consist of fiber-optic cables suitable for transmitting optical network information from the LAN switch to the various TRs provided as an intermediate link between the CER and the desktop locations receiving access to the LAN, that is, backbone 450′ may be a fiber-optic backbone.

Horizontal portion 650′ may include a plurality of TRs 600A′-600D′ which, for example, may be provided on separate floors of an office building, complex, etc. Alternatively, more than one TR may be provided on a single floor. Any particular arrangement may depend on the design and dimensions of the building being cabled for network access. The TRs may be connected to a plurality of active outlets 100a′-100j′ provided, for example, at desktop locations on the same floor as one or more of the TRs 600A′-600D′.

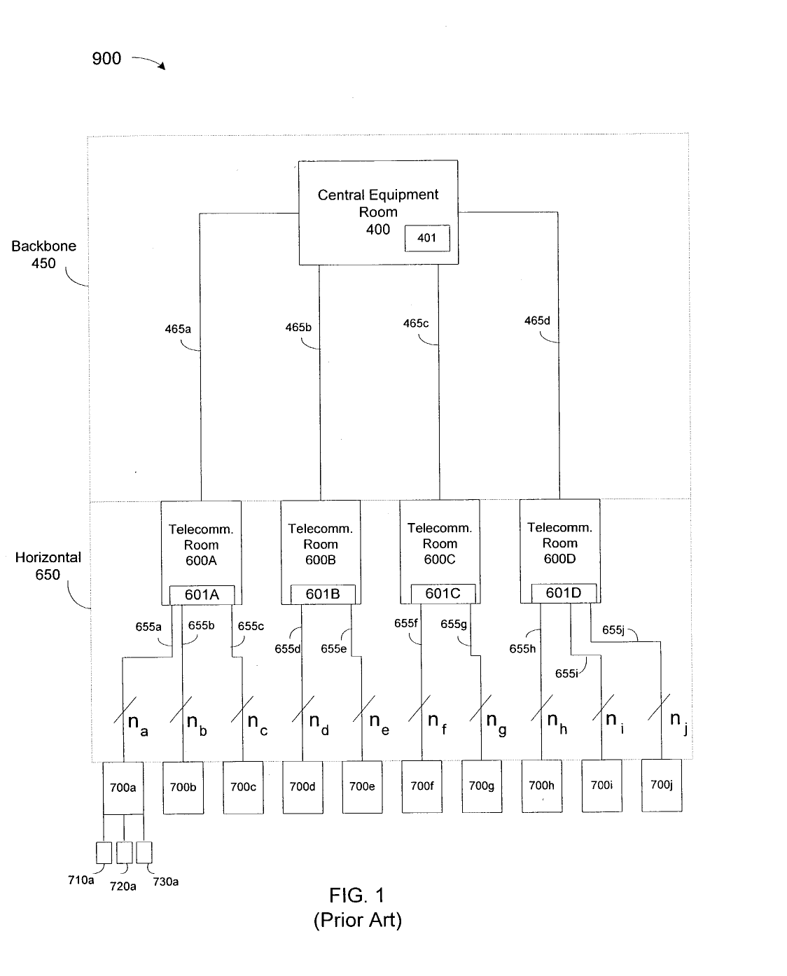

It should be appreciated that providing active outlets at the various desktop locations facilitates providing a fiber-optic horizontal portion of the structured cabling system. For example, the switches 601A-601D illustrated in the conventional structured cabling system of FIG. 1 may be removed from the TRs 600A′-600D′ since the switching of the network signals to the individual desktop devices is handled by the active outlet at each desktop location. Furthermore, the individual electrical cables connecting the switches of the TRs with each of the various network components at a desktop location in conventional structured cabling structures may be replaced by a single fiber-optic cable. For example, fiber-optic cables 665a-665j may transmit the network information required by desktop locations 700a′-700j′, respectively. For example, a workstation 710a′, a network printer 720a′, and laptop computer 730a′ may be connected to the active outlet 100a′. Network information ultimately bound for any of the devices 710a′-730a′may be transmitted as optical signals over the single fiber optic cable 665a and then converted to electrical signals and switched to the appropriate device by the active outlet at the desktop location. As such, the structured cabling system 950 facilitates providing optical media as the primary transport from the LAN all the way to the desktop location such that the various advantages and benefits of optical technology may be exploited.

In some embodiments, one or more electrical cables may be pulled from the TR to the active outlets to provide power and/or circuit switched data to the individual desktop locations. For example, electrical cables 655a-655j may connect patch panels 500a-500d to electrical connectors on the back side of active outlets 100a′-100j′ to provide power from a secure remote location and telephone and fax/modem data from the circuit switch servicing the building and/or campus location.

It should be appreciated that various aspects of the present invention facilitate transition to an optical structured cabling system by bringing optical media all the way to the desktop. As such, versatile, maintainable, high bandwidth structured cabling systems that are less vulnerable to obsolescence may be implemented using, for instance, existing TRs as an intermediate link between an optical backbone and an optical horizontal portion.

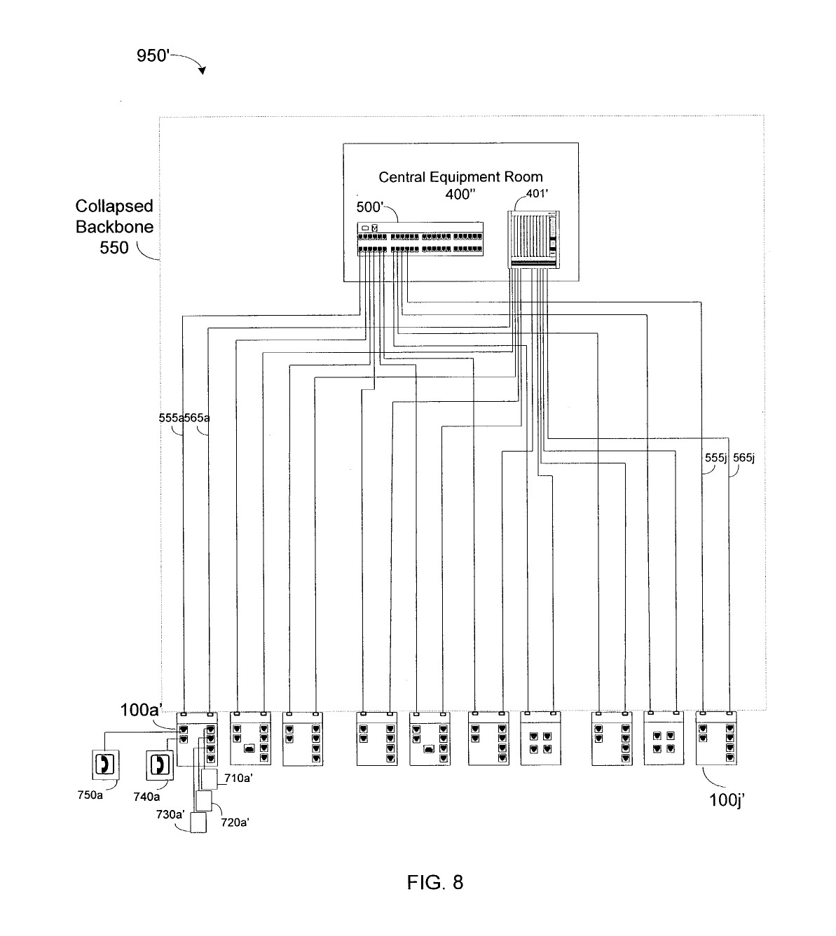

FIG. 8 illustrates another structured cabling system according to the present invention. Structured cabling system 950′ includes an CER 400″ having a LAN switch 401′. The CER may be connected to a plurality of active outlets 100a′-100j′. The architecture illustrated in FIG. 8 is often referred to as a collapsed backbone structure because the backbone portion and the horizontal portion are collapsed into essentially a single link segment between the CER and the various desktop locations connected to the network. This structure has also been referred to as a centralized structured cabling system.

In conventional collapsed backbone or centralized cabling systems, however, an individual cable must be pulled from the CER to the desktop for each individual device at a desktop location that may require network access. In FIG. 8, the switching and media conversion is accomplished at the active outlet and, as such, only a single fiber optic cable is required in order to support all of the network requirements of the network devices at a desktop location. For example, network devices 710a′, 720a′ and 730a′ may receive network access through active outlet 100a′from single fiber-optic cable 565a. As such, the bulky cabling infrastructure that has complicated conventional centralized cabling structures may be mitigated by employing active wall outlets at the desktop.

In addition, active outlets 100a′-100j′ may receive power and/or circuit switched data from the CER. For example, patch panel 500′ may provide power from a secure power source such as a UPS (not shown) located in the CER to a first set of pins of one or more ports on the front face of the patch panel. Furthermore, patch panel 500′ may receive circuit switched information from the telephone switch (not shown) and apply circuit switched information to a second set of pins of one or more ports of patch panel 500′. As such, in the structured cabling system illustrated in FIG. 8, power, telephone, and/or fax/modem information may be provided to the desktop over a single electrical cable, such as CAT 5 UTP cable or the like. Alternatively, the CER may not include a patch panel, and one or more patch panels may be distributed in TRs located around the building to provide remote power and/or circuit switched data as described in connection with FIG. 7.

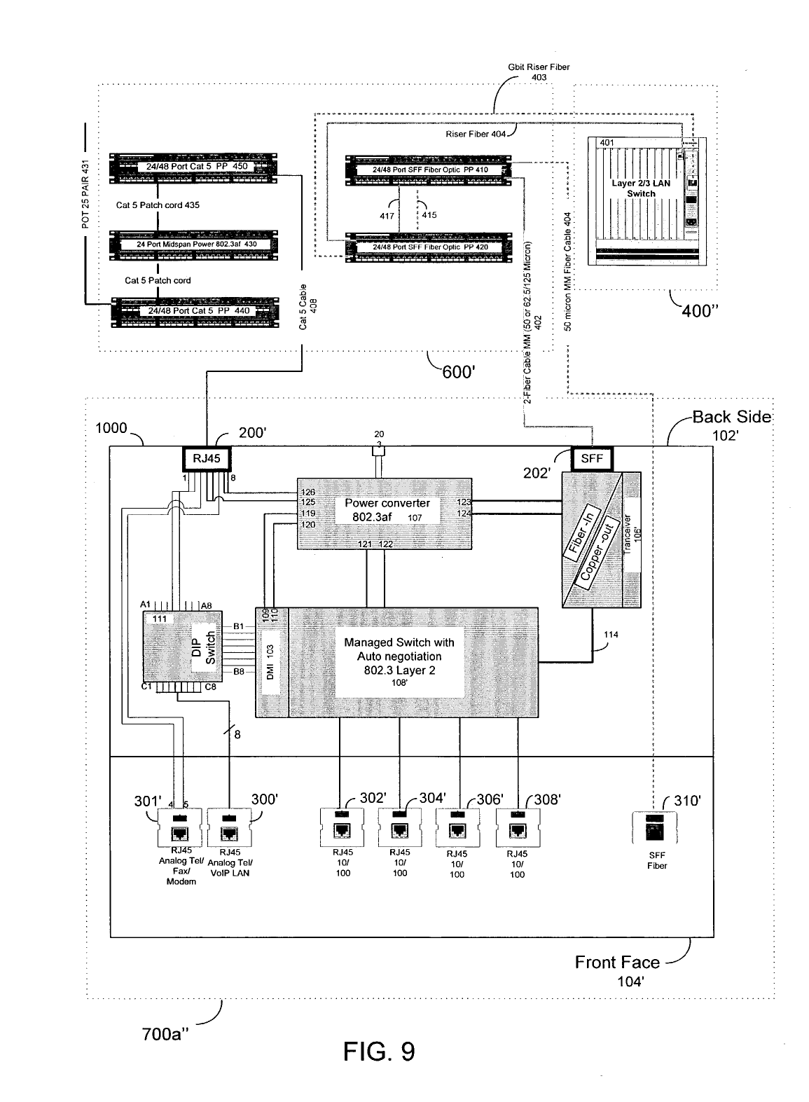

FIG. 9 illustrates an embodiment incorporating various aspects of the present invention. A desktop location 700a″ includes an active wall outlet 1000. Active wall outlet 1000 includes a transceiver 106′ configured to convert between optical signals received from SFF optical connector 202′ and electrical signals received at terminal 114. Transceiver 106′ may operate as a bi-directional media converter configured to provide signal conversion between, for example, a fiber optic network and an electrical desktop.

Switch 108′ may be coupled to transceiver 106′ by a connection 114 suitable for providing electrical signals from the transceiver to the switch and from the switch to the transceiver. As such, connection 114 may be a bidirectional connection or may comprise one or more unidirectional connections providing the exchange of the electrical signals in one of either a direction from the transceiver to the switch or vice versa. Switch 108′ may be, for example, a managed switch having auto negotiation capabilities, for instance, in compliance with a Layer 2 switch according to the IEEE 802.3 definition, which is hereby incorporated by reference in its entirety. However, switch 108′ may be of any type suitable for switching signals amongst a plurality of ports.

In order to provide network information to any of various desktop devices, a plurality of electrical connectors, for example, RJ45 connectors 302, 304, 306 and 308 are coupled to the switch and provided on front face 104′ of the active wall outlet. Switch 108′ may be configured such that network devices connected at connectors 302, 304, 306 and 308 may be provided with 10 mbps or 100 mbps (10/100) network access.

In addition, one or more additional optical connectors may be provided on the front face of the active outlet in order to provide a fiber optic cable pass-through. For example, an SFF connector 310 may be provided on the front of the active outlet such that, for example, Gbit optical fiber may be passed through the active wall outlet. As such, active outlet 1000 is configured to provide both LAN access and WAN and/or ATM services to desktop location 700a″.

Active outlet 1000 may be connected to a LAN in a structured cabling system as illustrated FIG. 9. In particular, active outlet 1000 may be connected to a electronics room 600′ by fiber-optic cable 402. Fiber optic cable 402 may be a 2-Fiber cable, for instance, a 50 or 62.5/125 Micron multimode fiber optic cable. However, fiber optic cable 402 may be any optical media capable of transmitting optical signals. The type of cabling and connectors used may vary as optical technology evolves and standards change. As such, active outlet 1000 may be configured to provide 10/100 network support and to support 1000FX network support and/or any progeny thereof.

Fiber optic cable 402 may be connected at one of the ports provided by patch panel 410 located in the electronics room. Patch panel 410 may include a plurality of ports configured to provide optical network information to components connected at the ports over a suitable fiber optical cable. Patch panel 410 is illustrated as 24/48 port SFF patch panel, however, any number of ports may be provided and may depend upon the size of the network, the number of desktop locations connected to the TR, and any of various other design concerns relevant to a particular structured cabling system implementation.

Patch panel 410 is connected to patch panel 420 located in the TR by patch cords 415 and 417. Patch panel 420 may be connected by riser fiber 404 and/or gigabit (Gbit) riser fiber 403 to CER 400″. The CER may house a LAN switch, for example, a Layer 2/3 switch compliant with the IEEE 802.3 definition. In this way, network activity is routed from the computer equipment room 400″ to patch panel 420 over optical media and provided to patch panel 410 to be distributed at the various ports providing access to a plurality of desktop locations over optical media.

Active wall outlet 1000 may also include a power converter 107 configured to receive power from an external source and convert the power as necessary to provide power to the various components of the active wall outlet. For example, power converter 107 may be connected to a first set of pins of electrical connector 200 in order to receive power from an external location. Power converter 107 may then be coupled to transceiver 106, switch 108 and/or DMI 103. According to one embodiment, power converter 107 receives −48 VDC power from pins 4, 5, 7 and 8 of RJ45 electrical connector 200, for instance, in compliance with the IEEE 802.3af power over twisted pair definition. Power converter 107 may then convert the power to a voltage level suitable for operating the various components in the active wall outlet. For example, power converter 107 may convert a portion of the power received from connector 200 to, for example, a +/−5 volt signal provided at terminals 121 and 122 connected to switch 108′. Similarly, power converter 107 may convert a portion of the power received from connector 200 to a +/−5 or +/−12 volt signal provided at terminal 123 and 124 connected to transceiver 106′.

It should be appreciated that power converter 107 may be configured to convert power received externally to any voltage level required by the various components of the active wall outlet. For example, power converter 107 may be configured to provide and control power to DMI 103 provided to manage the network voice interface as described in greater detail below. In addition, power converter 107 may be configured to receive power from connector 203 on the backside of the outlet. Accordingly, the AC supply from the wall may be provided to power converter 107 to be converted and distributed appropriately to the various components in the active wall outlet.

Active wall outlet 1000 may also provide telephone and fax services to desktop location 700a″. For example, active wall outlet 1000 may include a DIP switch 111. Dip switch 111 may, for example, have a first set of pins A1-A8, a second set of pins B1-B8 and a third set of pins C1-C8. The DIP switch may be configured to either connect the first set of pins A1-A8 with the third set of pins C1-C8 or connect the second set of pins B1-B8 with the third set of pins C1-C8. As illustrated, one or more of the pins of electrical connector 200′ may be connected to one or more of pins A1-A8. Similarly, one or more of pins B1-B8 may be connected to DMI 103. In the embodiment illustrated in FIG. 9, pins 1 and 2 of electrical connector 200′ may be connected to pins A4 and A5, each of pins B1-B8 may be connected to DMI 103 and an electrical connector 300′ may be connected to one or more of pins C1-C8. This configuration permits the active wall outlet to provide, for example, either analog telephone service or network voice service by switching DIP switch 111 to pass the appropriate signals to pins C1-C8. In particular, when analog telephone service is desired, DIP switch 111 may be configured to pass signals received at A1-A8 to pins C1-C8. When network voice service is desired, DIP switch 111 may be set to pass signals received at B1-B8 to pins C1-C8. As such, active wall outlet 1000 is capable of providing either analog telephone service or network voice service, for instance, VoIP service to devices connected to connector 300′. Connector 300′ may be of the RJ11, RJ21, RJ45 form factors, etc.

DMI 103 is provided to interface between the switch and, ultimately, electrical connector 300. DMI 103 may be powered by power converter 107. For example, power converter 107 may provide −48 VDC to DMI 103 when the DIP switch has been configured to pass signals received at pins B1-B8. Power converter 107 may be configured to automatically detect when power is required by DMI 103. For example, when DIP switch 111 is configured to pass signals from pins A1-A8 to C1-C8, power converter 107 may detect an open circuit condition at B1-B8 and not provide operating power to DMI 103. However, if DIP switch 111 is switched over or is configured to pass signals from B1-B8 to C1-C8, power converter 107 may detect a load condition and begin providing operating power to DMI 103. In one embodiment, power provided from power converter 107 is provided, for example, to pins 4, 5, 7 and 8 and data provided from the switch is provided to pins 1, 2, 3 and 6. For example, pins 4 and 5 may carry a reference or ground potential and pins 7 and 8 may carry a supply potential.

FIG. 9 further illustrates a method and apparatus for providing power and/or circuit switched data from TR 600′. TR 600′ may include a midspan power supply 430 providing power, for example, in compliance with IEEE 802.3af. Patch panel 450 may be connected to midspan power supply 430 by patch cord, such as CAT 5 cable 435 to provide termination and a test point for power from midspan power supply 430. Patch panel 450 may provide power received from midspan power supply 430 to a first set of pins of one or more ports of the patch panel 450. As such, a plurality of desktop locations may receive power from the telecommunication room by connecting a suitable electrical cable from an active outlet to one of the ports of patch panel 450. For example, active wall outlet 1000 may be connected to one of the ports of patch panel 450 which provides power from midspan supply 430 provided at pins 4, 5, 7 and 8 of electrical connector 200.

In addition, a patch panel 440 may be included such that voice and/or data, for example, circuit switched data, may be provided to the active wall outlet. In FIG. 9, patch panel 440 is connected to a telephone circuit switch (not shown) via cable 431, for example, a POTS 25 pair cable. Information received over cable 431 is provided to patch panel 450. Patch panel 450 then provides the information on a second set of pins to one or more of the ports. As such, both power and circuit switched data may be provided to active wall outlet 1000 over a single electrical cable. For example, active wall outlet 1000 may provide power to the various components of the active outlet and provide circuit switched data, for example, POTS, fax, and/or modem service to devices connected to electrical connectors 300′ and 301′ on the front face of the outlet.

Having thus described at least one illustrative embodiment of the invention, various alterations, modifications and improvements will readily occur to those skilled in the art. Such alterations, modifications and improvements are intended to be within the scope of the invention. Accordingly, the foregoing description is by way of example only and is not intended as limiting. Accordingly, the foregoing description and figures are by way of example only and the invention is limited only as defined in the following claims.

What is claimed is:

1. An active wall outlet comprising:
at least one optical connector;
a plurality of ports;
a transceiver configured to convert between optical signals and electrical signals, the transceiver capable of transmitting and receiving optical signals to and from at least one optical connector; and
a switch coupled to the transceiver and at least some of the plurality of ports, the switch configured to switch electrical signals between the transceiver and at least some of the plurality of ports.

2. The active wall outlet of claim 1, further comprising a first electrical connector.

3. The active wall outlet of claim 2, further comprising a power converter configured to provide power to at least one of the transceiver and the switch.

4. The active wall outlet of claim 3, wherein the power converter is configured to receive a first voltage signal from the first electrical connector and provide a second voltage signal to at least one of the transceiver and the switch.

5. The active wall outlet of claim 4, wherein the power converter converts the first voltage signal into the second voltage signal.

6. The active wall outlet of claim 5, wherein the power converter provides the second voltage signal to the transceiver and the switch.

7. The active wall outlet of claim 5, wherein the power converter further converts the first voltage signal into a third voltage signal.

8. The active wall outlet of claim 7, wherein the power converter provides the second voltage signal to the transceiver and the third voltage signal to the switch.

9. The active wall outlet of claim 4, wherein the plurality of ports include a second electrical connector.

10. The active wall outlet of claim 9, wherein the second electrical connector is coupled to the first electrical connector and wherein the first and second electrical connectors are configured to provide analog telephone service to devices connected to the second electrical connector.

11. The active wall outlet of claim 9, wherein the switch is configured to provide network voice information from the transceiver to the second electrical connector.

12. The active wall outlet of claim 9, further comprising a DIP switch coupled the switch, the first electrical connector and the second electrical connector, wherein the DIP switch is capable of being configured to pass one of signals received from the first electrical connector to the second electrical connector and signals received from the switch to the second electrical connector.

13. The active wall outlet of claim 12, wherein the DIP switch can provide plain old telephone service (POTS) when configured to pass signals received from the first electrical connector and network voice information when configured to pass signals received from the switch.

14. The active wall outlet of claim 9, wherein the first electrical connector has a plurality of pins including a power set of pins configured to provide power and a first data set of pins configured to provide circuit switched data.

15. The active wall outlet of claim 14, wherein the power converter is coupled to the power set of pins and the second electrical connector is coupled to the first data set of pins.

16. The active wall outlet of claim 14, further comprising a DIP switch having a first, second and third plurality of pins, the DIP switch capable of being configured to connect one of the first plurality and the second plurality of pins with the third plurality of pins, wherein a first set of the first plurality of pins are connected to the first data set of pins, a second set of the second plurality of pins are connected to the switch, and a third set of the third plurality of pins are connected to the second electrical connector.

17. The active wall outlet of claim 16, wherein the switch includes a network interface connected to the second set of the second plurality of pins.

18. The active wall outlet of claim 17, wherein the power converter is coupled to the power set of pins and configured to further provide power to the network interface.

19. The active wall outlet of claim 18, wherein the power converter converts a first voltage signal received at the power set of pins into a second voltage provided to the network interface.

20. The active wall outlet of claim 19, wherein the network interface is a DMI.

21. The active outlet of claim 19, wherein the power converter is configured to provide the second voltage to the network interface when sensing a load condition caused by the DIP switch being configured to connect the second plurality of pins to the third plurality of pins and to not provide the second voltage to the network interface when sensing an open circuit condition caused by the DIP switch being configured to connect the first plurality of pins to the third plurality of pins.

22. The active wall outlet of claim 21, further comprising a third electrical connector, the third electrical connector coupled to a second data set of pins of the plurality of pins of the first electrical connector.

23. The active wall outlet of claim 21, wherein the active wall outlet is configured to provide POTS to devices connected at the second electrical connector when the DIP switch is configured to connect the first plurality of pins with the third plurality of pins and to provide network voice service to devices connected to the second electrical connector when the DIP switch is configured to connect the second plurality of pins with the third plurality of pins.

24. The active wall outlet of claim 1, wherein the plurality of ports include at least one optical connector configured to terminate and provide an optical pass-through for a fiber optic cable.

25. The active outlet of claim 12, wherein the at least one optical connector includes at least a first optical connector coupled to the transceiver and at least a second optical connector coupled to at least one of the plurality of ports to provide an optical pass-through.

26. The active wall outlet of claim 1, wherein the switch is an Ethernet switch.

27. The active wall outlet of claim 1, wherein the plurality of ports include at least one of an RJ45 connector, at least one port providing 10/100 TX support, and at least one port providing 1000FX support.

28. The active outlet of claim 1, wherein the active outlet is configured to fit into a standard 4 inch by 4 inch wall outlet fixture.

29. The active outlet of claim 1, wherein the active outlet is configured to fit into a standard 4 inch by 6 inch wall outlet fixture.

30. The active outlet of claim 4, in combination with a remote power source.

31. The combination of claim 30, wherein the remote power source includes at least one patch panel having a plurality of ports, each port including a plurality of pins.

32. The combination of claim 31, wherein the at least one patch panel is configured to provide a first voltage signal at a power set of the plurality of pins of each of the plurality of ports.

33. The combination of claim 32, wherein the power converter is configured to receive power from the remote power source via the first electrical connector.

34. The combination of claim 33, wherein the remote power source includes a midspan power source.

35. The combination of claim 33, wherein the remote power source includes an uninterruptible power source (UPS) component.

36. The combination of claim 32, wherein the at least one patch panel is configured to provide circuit switched data at a data set of the plurality of pins of each of the plurality of ports.

37. The combination of claim 36, wherein the active wall outlet is configured to receive power and circuit switched data from the remote power source via the first electrical connector.

38. The combination of claim 32, in combination with a plurality of active outlets, each active outlet connected to one of the plurality of ports of the at least one patch panel.

39. The combination of claim 38, in combination with a structured cabling system comprising:
a network switch remote from the plurality of active outlets configured to switch network information;
a plurality of optical cables connecting the network switch and the plurality of active outlets to provide the network information to the at least one optical connector of each of the plurality of active outlets; and
a plurality of electrical cables connecting each of the plurality of active outlets to one of the plurality of ports of the at least one patch panel.

40. The combination of claim 39, further comprising at least one intermediate patch panel, wherein a first set of the plurality of optical cables is connected to the network switch at a first end of each optical cable of the first set and to the at least one intermediate patch panel at a second end of each optical cable of the first set and a second set of the plurality of optical cables is connected to the at least one intermediate patch panel at a first end of each optical cable of the second set and to the plurality of active wall outlets at a second end of each optical cable of the second set.

41. The combination of claim 40, wherein at least one patch panel and at least one intermediate patch panel are located proximate each other.

42. A method of providing network information to a desktop comprising acts of:
providing at least one optical signal to an active outlet having a plurality of ports from a network over at least one first optical cable;
converting the at least one optical signal to at least one electrical signal at the active outlet; and
switching the at least one electrical signal amongst the plurality of ports at the active outlet.

43. The method of claim 42, wherein the act of providing at least one optical signal includes an act of providing optical network information over at least one first optical cable from a network switch remote from the active outlet.

44. The method of claim 42, wherein the act of providing at least one optical signal includes an act of providing optical network information over the at least one first optical cable from a telecommunications room remote from the active outlet.

45. The method of claim 44, wherein the act of providing optical network information includes an act of providing optical network information to the telecommunications room over at least one second optical cable from a network switch remote from the telecommunications room.

46. The method according to claim 45, further comprising an act of providing power to the active outlet from a location remote from the desktop.

47. The method according to claim 46, wherein the act of providing power includes an act of providing power to the active wall outlet over an electrical cable.

48. The method of claim 47, further comprising an act of providing circuit switched data to the active outlet.

49. The method of claim 48, wherein the act of providing power and the act of providing circuit switched data includes an act of providing at least one power signal to a first power set of pins of the electrical cable and providing the circuit switched data to a first data set of pins of the electrical cable.

50. The method of claim 49, wherein the acts of providing power and circuit switched data includes an act of providing the electrical cable to an electrical connector of the active outlet.

51. The method of claim 50, wherein the acts of providing power and circuit switched data includes an act of providing power and circuit switched data to a patch panel and providing at least one power signal to a second power set of pins and circuit switched data to a second data set of pins of each of a plurality of ports of the patch panel.

52. The method of claim 51, wherein the acts of providing power and circuit switched data include connecting the electrical cable to one of the plurality of ports of the patch panel.

53. The method according to claim 45, further comprising an act of providing circuit switched data to the active outlet.

54. The method of claim 53, wherein the act of providing circuit switched data includes providing circuit switched data to the active outlet over at least one electrical cable connected at a first electrical connector of the active outlet.

55. The method of claim 54, wherein the act of providing circuit switched data includes an act of providing the circuit switched data from the first electrical connector to a second electrical connector of the active outlet through a DIP switch having a first, second, and third set of pins, and wherein the first electrical connector is coupled to the first set of pins and the second electrical connector is coupled to the second set of pins.

56. The method of claim 55, wherein the act of providing circuit switched data includes an act of configuring the DIP switch to pass signals from the first set of pins to the second set of pins.

57. The method of claim 55, further comprising an act of providing network voice information at the active outlet.

58. The method of claim 57, wherein the act of switching the at least one electrical signal includes an act of switching network voice information to the second electrical connector via the third set of pins.

59. The method of claim 58, further comprising an act of providing one of circuit switched data and network voice information to the second connector by configuring the DIP switch to pass one of signals from the first set of pins to the second set of pins and signals from the third set of pins to the second set of pins.

60. The method according to claim 42, further comprising the act of passing an optical signal through the active outlet.

61. A structured cabling system providing optical media to a plurality of desktops, the structured cabling system comprising:
at least one network switch located remote from the plurality of desktops, the at least one network switch configured to provide optical network information over at least one first optical cable; and
at least one active wall outlet remote from the network switch having a plurality of ports, the active outlet capable of receiving the optical network information and configured to convert the optical network information to electrical network information and switch the electrical network information between the plurality of ports.

62. The structured cabling system of claim 61, wherein the at least one active wall outlet includes a first optical connector configured to receive the optical network information from the at least one optical cable.

63. The structured cabling system of claim 61, further comprising at least one telecommunications room remote from the at least one switch, the at least one telecommunications room configured to receive the optical network information from the at least one first optical cable and provide the optical network information to at least one of the active outlets over at least one second optical cable.

64. The structured cabling system of claim 63, wherein the at least one telecommunications room includes at least one patch panel, the patch panel configured to terminate at least one first optical cable and provide the optical network information over at least one second optical cable.

65. The structured cabling system of claim 63, wherein the at least one active wall outlet further includes a first optical connector capable of receiving at least one second optical cable.

66. The structured cabling system of claim 65, wherein the optical network information is received by the at least one active outlet at the first optical connector.

67. The structured cabling system of claim 66, wherein the at least one active wall outlet includes a converter capable of converting the optical network information received at the first optical connector to electrical network information.

68. The structured cabling system of claim 67, wherein the at least one active wall outlet includes a switch capable of receiving the electrical network information from the converter and switching the electrical network information amongst the plurality of ports.

69. The structured cabling system of claim 68, further comprising a plurality of network devices connected to at least some of the plurality of ports of at least one active wall outlet, wherein the switch of the at least one active wall outlet is capable of receiving electrical network information from the plurality of network devices connected to at least some of the plurality of ports and providing the electrical network information to the converter.

70. The structured cabling system of claim 69, wherein the converter is capable of converting the electrical network information received from the switch into optical network information and providing the optical network information to the first optical connector.

71. The structured cabling system of claim 65, further comprising at least one power source configured to provide power over an electrical cable.

72. The structured cabling system of claim 71, wherein the at least one telecommunicates room includes at least one patch panel having a plurality of ports, the at least one patch panel configured to receive power from the at least one power source at a first power connector and to provide power signals to a power set of pins of each of the plurality of ports.

73. The structured cabling system of claim 72, wherein the at least one active outlet includes a first electrical connector configured to receive power over an electrical cable.

74. The structured cabling system of claim 73, further comprising at least one first electrical cable connecting the power source to at least one of the patch panels and at least one second electrical cable connecting one or more ports of the at least one patch panel with at least one of the active outlets.

75. The structured cabling system of claim 71, wherein the at least one power source includes an uninterruptible power source (UPS) configured to provide power to the first power connector of the at least one patch panel.

76. The structured cabling system of claim 71, wherein the at least one power source includes a midspan power source configured to provide midspan power to the first power connector of the at least one patch panel.

77. The structured cabling system of claim 73, wherein the patch panel is configured to receive circuit switched data at a second connector and provide the circuit switched data to a data set of pins of each of the plurality of ports of the at least one patch panel.

78. The structured cabling system of claim 77, wherein at least one active outlet is provided at least one of power and circuit switched data via at least one electrical cable between at least one of the plurality of ports of the at least one patch panel and the first electrical connector of the at least one active wall outlet.

79. The structured cabling system of claim 63, wherein the at least one telecommunications room is configured to provide at least one third fiber optic cable to the at least one active outlet.

80. The structured cabling system of claim 79, wherein the at least one third optical cable is connected to a second optical connector of the active wall outlet via an optical pass through.

81. The structured cabling system of claim 80, wherein the at least one third optical cable is connected to the second optical connector via a third optical connector of the active wall outlet coupled with the second optical connector via an internal pass through.

82. The structured cabling system of claim 80, wherein the optical pass through provides at least one of wide area network (WAN) and asynchronous transfer mode (ATM) services.

83. A structured cabling system for a Local Area Network (LAN) comprising:
a backbone portion providing optical network information over at least one optical cable;
a horizontal portion connected to the backbone portion by at least one first optical cable, the horizontal portion capable of receiving the optical network information from the at least one first optical cable and providing the optical network information over a plurality of second optical cables; and
a plurality of desktop locations connected to the horizontal portion by at least one of the plurality of second optical cables, each desktop location including an active wall outlet capable of receiving the optical network information over the at least one second optical capable, converting the optical network information into electrical network information and switching the electrical network information amongst a plurality of active wall outlet ports.

84. The structured cabling system of claim 83, wherein the horizontal portion provides the optical network information over a single second optical cable for each of the plurality of desktop locations.

85. The structured cabling system of claim 83, further comprising at least one power source.

86. The structured cabling system of claim 85, wherein the horizontal portion is configured to provide power from the power source to the plurality of desktop locations over a plurality of first electrical cables.

87. The structured cabling system of claim 86, wherein the horizontal portion is configured to provide power over a single first electrical cable for each of the desktop locations.

88. The structured cabling system of claim 87, wherein each active wall outlet of the plurality of desktop locations is configured to receive power from the single first electrical cable at a first electrical connector of the active outlet.

89. The structured cabling system of claim 88, wherein the horizontal portion is configured to provide circuit switched data from a circuit switch to the plurality of desktop locations over the plurality of first electrical cables.

90. The structured cabling system of claim 89, wherein the horizontal portion is configured to provide circuit switched data over the single first electrical cable for each of the desktop locations.

91. The structured cabling system of claim 90, wherein each active wall outlet of the plurality of desktop locations is configured to receive circuit switched data from the first electrical cable at the first electrical connector.

92. The structured cabling system of claim 83, wherein the backbone portion includes a central equipment room including at least one network switch.

93. The structured cabling system of claim 92, wherein the horizontal portion includes a plurality of telecommunications rooms located remote from the central equipment room and wherein the at least one first optical cable extend from the central equipment room to the plurality of telecommunications rooms and the plurality of second optical cables extend from the plurality of telecommunications rooms to the plurality of desktop locations.

94. The structured cabling system of 92, wherein the central equipment room includes at least one patch panel and wherein the at least one first optical cable extends between the at least one network switch and the at least one patch panel and the plurality of second optical cables extend between the at least one patch panel and the plurality of desktop locations such that the backbone portion and the horizontal portion form a collapsed backbone structure.

95. The structured cabling system of claim 93, wherein each telecommunications room is operatively connected to a set of desktop locations, each desktop location receiving from the telecommunications room optical network information over a first single optical cable and at least one of power and circuit switched data over a first single electrical cable, wherein the first single optical cable and the first single electrical cable are connected to the active wall outlet of the respective desktop location.
